(19) United States
(12) Patent Application Publication
(10) Pub. No.: US 2024/0329618 A1
(43) Pub. Date: Oct. 3, 2024

(54) Fault Detection In Buildings

(71) Applicant: Siemens Schweiz AG, Zürich (CH)

(72) Inventor: Ivo Brand, Küssnacht (CH)

(73) Assignee: Siemens Schweiz AG, Zürich (CH)

(21) Appl. No.: 18/616,533

(22) Filed: Mar. 26, 2024

(30) Foreign Application Priority Data
Mar. 29, 2023 (EP) 23165167.0

(51) Int. Cl. G05B 19/4063; G05B 19/408

(52) U.S. Cl. CPC G05B 19/4063; G05B 19/408; G05B 2219/21126

(57) ABSTRACT

Various embodiments of the teachings herein include a method of detecting faults in a structure. An example method includes: obtaining from an actuator a first signal indicative of a test operating mode and from a first and second sensor respective signals indicative of a time series of test readings; producing a test operating mode in response; searching for the test operating mode in a first list, and searching for sensors in a second list; if the test operation mode is in the first list and sensors are in the second list, determining a test numerical measure between the first time series and the second time series, including a predefined constant when the first time series matches the second and otherwise deviating from the predefined constant; and determining a test deviation of the measure from the predefined constant, and if the deviation exceeds a threshold, producing a fault.

### CROSS-REFERENCE TO RELATED APPLICATIONS

This application claims priority to EP application Ser. No. 23/165,167.0 filed Mar. 29, 2023, the contents of which are hereby incorporated by reference in their entirety.

### TECHNICAL FIELD

The present disclosure relates to detecting faults in a residential, commercial, and/or industrial building, and/or in a facility. some embodiments of the teachings of the present disclosure include buildings and/or facilities having a plurality of actuators and a plurality of sensors.

### BACKGROUND

Residential and/or commercial and/or industrial buildings commonly have a plurality of actuators such as valves and/or damper actuators and/or pumps. They control the heating and/or ventilation and/or air conditioning within the buildings. These buildings may also include actuators to set the positions of blinds. Actuators can also be intended to switch and/or dim lights.

In addition to these actuators, sensors such as light sensors and/or temperature sensors and/or sensors for measuring particulate matter and/or presence detectors can be provided. The sensors and the actuators are distributed throughout the various parts of a structure. They typically come with a communication interface and/or with a communication controller to communicate with one another and/or with one or more system controllers. The one or more system controllers can be installed on-site. The one or more system controllers can also comprise a remote controller. The one or more system controllers can, by way of non-limiting example, comprise a cloud computer.

The communication interface and/or the communication controller can, for instance, rely on wireless solutions such as WLAN and/or KNX® RF and/or Enocean®. Hard-wired solutions such as Ethernet® cables and/or KNX® cables are also common. The choice of any wireless or hard-wired solution is influenced by bandwidth requirements. Sensor and/or actuators with video streaming functionality can, for instance, require more bandwidth than other types of field devices.

The sensors and the actuators thus form a network. Tyically, each device of the network can be identified through an address such as a media access control (MAC) address or an internet protocol (IP) address. One or more system controllers may, for instance, rely on direct host configuration and assign addresses to the actuators and/or to the sensors. The one or more system controllers and the actuators and/or the sensors then use these addresses and suitable protocols for communication purposes.

Upon installation of various actuators and/or sensors in a building and/or in a facility, these devices require commissioning and/or tests. That is, someone searches the various parts of a building for all the actuators and/or sensors. The commissioning personnel then record their identifications and their locations. The commissioning personnel can, for instance, create a table with device addresses and with device locations.

This known process of commissioning and/or testing has a number of shortcomings. The commissioning and/or test personnel searching for devices can, by way of example, miss one of the actuators and/or miss one of the sensors. The personnel can spend long hours searching for devices that are not obvious to find. Further, the personnel can make a mistake in writing down an address of an actuator or of a sensor. All those issues typically involve cost penalties and/or delays.

A European patent application EP3156858A1 deals with commissioning of sensors and actuators in buildings. More specifically, pairs of sensors and actuators are identified based on correlation coefficients. The correlation coefficients are calculated based on the settings and on the readings obtained from the actuators and from the sensors, respectively.

More than a hundred pumps and/or valves and/or heat meters are installed in some buildings. Tests of such buildings then turn into arduous and time-consuming exercises. Due to complexity, the odds of making mistakes during the test of such buildings are high.

### SUMMARY

The present disclosure describes systems and/or method for commissioning and testing of commercial and/or industrial and/or residential structures. The teachings of the present disclosure may be used for semi-automated commissioning and/or tests. The semi-automated commissioning and/or the tests of this disclosure alleviate fault detection in buildings.

For example, some embodiments include a method of detecting faults in a structure (1) having a data network and at least one first actuator (3a-3h, 4a-4e) connecting to the data network, and having first and second sensors (5a-5h), each sensor (5a-5h) connecting to the data network, the method comprising: obtaining via the data network from the at least one first actuator (3a-3h, 4a-4e) one or more signals indicative of a test operating mode and/or of a test operating state and from each of the first and second sensors (5a-5h) one or more signals indicative of a time series of test readings; producing a test operating mode and/or a test operating state from the one or more signals indicative of a test operating mode and/or of a test operating state and a first time series of test values from the one or more signals obtained from the first sensor (5a-5h) and a second time series of test values from the one or more signals obtained from the second sensor (5a-5h); searching for the test operating mode and/or for the test operating state in a first list, and searching for the first and second sensors (5a-5h) in a second list; if the test operation mode is found in the first list and the first and second sensors (5a-5h) are found in the second list: determining a test numerical measure s between the first time series of test values and the second time series of test values, the test numerical measure s being a predefined constant when the first time series of test values matches the second time series of test values and otherwise deviating from the predefined constant; determining a test deviation of the test numerical measure s from the predefined constant; if the test deviation exceeds a test threshold value: producing fault data based on the test deviation; and using the fault data to alert a user and/or an operator.

In some embodiments, the method comprises one or more iterations of: determining a distance d between the first time series of test values and the second time series of test values; rescaling the determined distance d between the first time series of test values and the second time series of test values; and adding the rescaled distance between the first time series of test values and the second time series of test values to or subtracting the rescaled distance between the first time series of test values and the second time series of test values from the test numerical measure S.

In some embodiments, the method comprises one or more iterations of: applying a moving window filter to the first time series of test values to obtain a first filtered test value; applying the moving window filter to the second time series of test values to obtain a second filtered test value; determining a distance d between the first filtered test value and the second filtered test value; rescaling the determined distance d between the first filtered test value and the second filtered test value; and adding the rescaled distance to or subtracting the rescaled distance from the test numerical measure s.

In some embodiments, each iteration comprises: comparing the determined distance d to a distance threshold value; and if the determined distance d exceeds the distance threshold value: using a first multiplicative factor c₁ to rescale the determined distance d; otherwise: using a second multiplicative factor c₂ to rescale the determined distance d; wherein the first multiplicative factor c₁ is different from the second multiplicative factor c₂.

In some embodiments, the method comprises if the test deviation exceeds the test threshold value: producing the fault data based on the test deviation and based on at least one of: the at least one first actuator (3a-3h, 4a-4e), the first sensor (5a-5h), the second sensor (5a-5h), and the test numerical measure s.

In some embodiments, the method comprises: obtaining via the data network from the at least one first actuator (3a-3h, 4a-4e) one or more signals indicative of an initial operating mode and/or of an initial operating state and from each of the first and second sensors (5a-5h) one or more signals indicative of a time series of initiation readings; producing an initial operating mode and/or an initial operating state from the one or more signals indicative of an initial operating mode and/or of an initial operating state and a first time series of initiation values from the one or more signals indicative of a time series of initiation readings obtained from the first sensor (5a-5h) and a second time series of initiation values from the one or more signals indicative of a time series of initiation readings obtained from the second sensor (5a-5h); and determining an initial numerical measure s between the first time series of initiation values and the second time series of initiation values, the initial numerical measure s being the predefined constant when the first time series of initiation values matches the second time series of initiation values and otherwise deviating from the predefined constant.

In some embodiments, the method comprises one or more iterations of: determining a distance d between the first time series of initiation values and the second time series of initiation values; rescaling the determined distance d between the first time series of initiation values and the second time series of initiation values; and adding the rescaled distance between the first time series of initiation values and the second time series of initiation values to or subtracting the rescaled distance between the first time series of initiation values and the second time series of initiation values from the initial numerical measure s.

In some embodiments, the method comprises: applying the moving window filter to the first time series of initiation values to obtain a first filtered initiation value; applying the moving window filter to the second time series of initiation values to obtain a second filtered initiation value; determining a distance d between the first filtered initiation value and the second filtered initiation value; rescaling the determined distance d between the first filtered initiation value and the second filtered initiation value; and adding the rescaled distance between the first filtered initiation value and the second filtered initiation value to or subtracting the rescaled distance between the first filtered initiation value and the second filtered initiation value from the initial numerical measure s.

In some embodiments, each iteration comprises: comparing the determined distance d to the distance threshold value; and if the determined distance d exceeds the distance threshold value: using the first multiplicative factor c₁ to rescale the determined distance d; otherwise: using the second multiplicative factor c₂ to rescale the determined distance d.

In some embodiments, the method comprises: producing the initiation data based on the initial numerical measure s and based on at least one of: the at least one first actuator (3a-3h, 4a-4e), the first sensor (5a-5h), the second sensor (5a-5h), an initial deviation of the initial numerical measure s from the predefined constant; forwarding the initiation data to the user and/or to the operator; after forwarding the initiation data, receiving from the user and/or from the operator a choice signal indicative of an affirmative or a negative choice made by the user and/or by the operator; producing a binary choice value indicative of the affirmative choice or of the negative choice from the choice signal; and if the binary choice value is affirmative: adding the initial operating mode and/or the initial operating state to the first list.

In some embodiments, the method comprises determining the test threshold value as a function of the initiation data.

In some embodiments, the method comprises: determining a measure of change of the first time series of initiation values; and if the measure of change exceeds a change threshold value: forwarding the initiation data to the user and/or to the operator.

In some embodiments, the method comprises: determining an or the initial deviation of the initial numerical measure s from the predefined constant and comparing the initial deviation to an initial threshold value; and if the initial deviation is less than the initial threshold value: adding the initial operating mode and/or the initial operating state to the first list.

As another example, some embodiments include a computer program comprising instructions to one or more system controllers (6a, 6b) in communicative connection with a data network to execute one or more of the methods described herein.

As another example, some embodiments include a computer-readable medium having stored thereon one or more of the computer programs as described herein.

### BRIEF DESCRIPTION OF THE DRAWINGS

Various features are apparent to those skilled in the art from the following detailed description of the disclosed non-limiting embodiments. The drawings that accompany the detailed description can be briefly described as follows:

FIG. 1 shows a building with a system controller incorporating teachings of the present disclosure disposed inside the building;

FIG. 2 shows a building with a system controller incorporating teachings of the present disclosure disposed outside the building;

FIG. 3 shows a heating and/or ventilation and/or air-conditioning system incorporating teachings of the present disclosure comprising a heat pump, various sensors and a thermal energy exchanger;

FIG. 4 illustrates two time series of signals;

FIG. 5 shows a plot of a measure of similarity versus a distance between two time series;

FIG. 6 depicts a plot of temperature versus time; and

FIG. 7 schematically shows a device incorporating teachings of the present disclosure for commissioning and/or test configured to connect to one or more system controllers.

### DETAILED DESCRIPTION

The present disclosure describes commissioning and/or testing buildings. To that end, a communication network is established among a plurality of sensors and among a plurality of actuators. By establishing a communication network, the sensors and the actuators (each) obtain addresses such that they can be identified. During commissioning and/or test, readings are obtained from the sensors such as from lighting sensors and/or from presence detectors and/or from thermometers. Additionally, signals indicative of operating modes and/or of operating states are obtained from the various actuators such as valve actuators and/or actuators for blinds and/or damper actuators.

The readings from the various sensors are exploited by estimating a measure of similarity between these readings. More specifically, a first time series of signals is obtained from a first sensor and a second time series of signals obtained from a second sensor. The measure of similarity is estimated as a function of the first and second time series. A moving maximum filter is applied to the second series to obtain an upper-bound series from the second series. A moving minimum filter is applied to the second series to obtain a lower-bound series from the second series. The moving maximum filter and the moving minimum filter preferably each have a window size. The moving maximum filter and the moving minimum filter ideally have the same window size. If the first time series is within the lower envelope series and the upper envelope series for a given time span, the signals will substantially be similar.

Where signals from two different sensors are found to be similar, these signals can be paired with an operating mode and/or with an operating state. To that end, signals indicative of operating modes and/or of operating states are obtained from the various actuators within the building and/or within the facility. The signals indicative of operating modes and/or of operating states can also be obtained from one or more system controllers of or for the site.

Operating mode data and/or operating state data are produced from the signals indicative of operating modes and/or of operating states. The operating mode data and/or the operating state data may contain pairs of data, each pair comprising an operating mode and/or an operating state of an actuator and a time stamp. If the time stamp of an operating mode and/or of an operating state matches the time when two signals are similar, the operating mode and/or the operating state will be associated with the two signals. A triplet comprising series of signals obtained from the first and second sensors and an operating mode and/or an operating state can thus be formed. A triplet comprising series of signals obtained from the first and second sensors and a pair of data associated with the operating mode and/or with the operating state can also be formed. The triplets are eventually presented to a user and/or to an operator of the site. For example, a mobile handheld device can be used to display a graphical user interface. The graphical user interface presents the triplets to the user and/or to the operator such that triplets can be selected from among the presented triplets.

The selection made the user and/or by the operator is eventually used to perform automated tests. Whenever an operating mode and/or an operating state of an actuator is present, the signals originating from the first and second sensors will be checked. If a time series originating from the first sensor and a time series originating the second sensor are dissimilar, an alert may be produced. The alert may be presented to the user and/or to the operator.

In some embodiments, dissimilarities between sensor signals are assigned to root causes. For example, a dissimilarity between signals obtained from an actuator and signals obtained from a sensor can indicate a faulted pump. These signals can also indicate a faulted heat meter. An alert can consequently be produced and can be sent to the user and/or to the operator.

In some embodiments, dissimilarities between sensor signals are assigned to root causes. For example, a dissimilarity between signals obtained from a sensor close to a thermal energy exchanger and wall-mounted sensor can indicate an open window. An alert indicative of an open window may thus be produced and be forwarded to the user and/or to the operator.

Not all the triplets comprising signals and operating modes and/or operating states are meaningful triplets. Even if two signals are similar, they need not be associated with a given operating mode and/or with a given operating state. For example, two sensors on the seventh floor of a site are generally not linked to an operating mode and/or to an operating state of an actuator installed elsewhere. More specifically, the two sensor signals are generally not associated with a mode or a state of window blinds installed on the first floor of that site.

To differentiate meaningful triplets from not meaningful triplets, the operating modes and/or the operating states are separated timewise. A first time span is determined. During the first time span, a first operating mode of a first actuator does not overlap with a second operating mode of a second actuator. During the first time span, a first operating state of a first actuator does also not overlap with a second operating state of a second actuator. During a second time span, the second operating mode of the second actuator does not overlap with the first operating mode of the first actuator. During a second time span, the second operating state of the second actuator does also not overlap with the first operating state of the first actuator.

The similarity between the first time series obtained from the first sensor and the second time series obtained from the second sensor may be evaluated at least twice. A first evaluation focuses on the first time span when the second operating mode and/or the second operating state is not activated. A second evaluation focuses on the second time span when the first operating mode and/or the first operating state is not activated. The first evaluation yields a first partial measure of similarity, and the second evaluation yields a second partial measure of similarity. If the first partial measure of similarity exceeds the second partial measure of similarity, the triplet will be assigned to the first operating mode and/or to the first operating state. The triplet will otherwise be assigned to the second operating mode and/or to the second operating state.

Additional rules can be applied to rule out coincidental triplets. For example, signals from temperature sensors may be considered dissimilar when there is no flow through an associated heat exchanger. A condition of no fluid flow through the associated heat exchanger can be directly identified using measurements. A condition of now flow can be indirectly identified from temperature readings that fluctuate around room temperature. A condition of now flow can still be indirectly identified from temperature readings that fluctuate around a reference temperature.

It can make sense to rank triplets before presenting them to a user and/or to an operator. Triplets can, for example, be ranked in accordance with a measure of similarity associated with each triplet. Triplets can also be preselected based on the user's and/or the operator's preferences. It is envisaged that such preferences are derived from past choices made by the user and/or by the building operator.

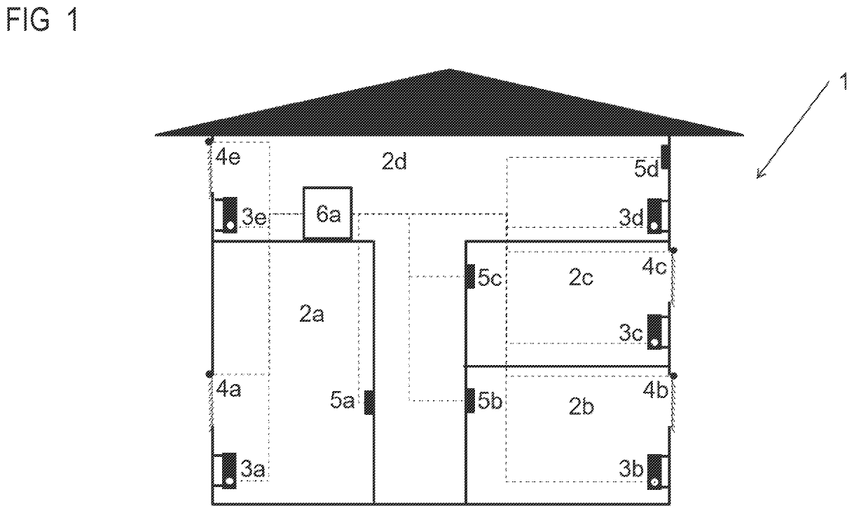

The building 1 and/or the facility as shown in FIG. 1 could be any commercial and/or residential and/or industrial structure. The building 1 and/or the facility comprises a plurality of rooms 2a-2d. The rooms 2a-2d of the building 1 and/or of the facility come with actuators 3a-3h, 4a-4e and with sensors 5a-5d. A first group of actuators 3a-3h as shown in FIG. 1 comprises valve actuators of room heaters or cooling devices or heating and cooling devices. The heating and cooling devices can, by way of non-limiting example, comprise fan coil units. The heating and cooling devices can, by way of another non-limiting example, be fan coil units. A second group of actuators 4a-4e actuates window blinds.

Other actuators such as damper actuators for ducts can be employed in the building 1 and/or in the facility. They can be commissioned and/or tested in accordance with the embodiments disclosed herein.

The sensors 5a-5d are, by way of non-limiting example, thermometers, pressure sensors, humidity sensors, lighting sensors, presence detectors, air quality sensors, sensors for particulate matter or any combination thereof. It is envisaged that the sensors 5a-5d are provided by a thermostat such as by a smart thermostat. The sensors 5a-5d can also be provided by another room unit or by a room device that measures temperature. The sensors 5a-5d can, by way of another example, be provided by fire detectors or by alarm units. The sensors 5a-5d, can be part of standard infrastructure such as computers or internet routers with temperature sensors etc.

In some embodiments, at least one of the actuators 3a-3h, 4a-4e or at least one of the sensors 5a-5d is operable to estimate and/or to determine its location. To that end, the device 3a-3h, 4a-4e, 5a-5d, can provide a circuit component for satellite navigation such as a global positioning system (GPS). The device 3a-3h, 4a-4e, 5a-5d can provide a circuit component harnessing another technology for navigation or object location. For example, the device 3a-3h, 4a-4e, 5a-5d can employ one or more wireless network adapters to estimate its location and to indicate movement. For example, a European patent application EP3186657A1 deals with a method, a digital tool, a device and a system for detecting movements of objects and/or living beings in a radio range. More specifically, EP3186657A1 and EP3186657B1 deal with detection of such movements in an indoor area.

In an embodiment, an actuator 3a-3h, 4a-4e or a sensor 5a-5d measures signal strengths of wireless signals. The device 3a-3h, 4a-4e, 5a-5d then uses triangulation to determine its proximity to radio frequency devices nearby. An actuator 3a-3h, 4a-4e or a sensor 5a-5d can, for instance, rely on wireless internet signal strength to obtain an estimate of its location.

The device 3a-3h, 4a-4e, 5a-5d can also use a sensor for particulate matter to estimate its location. High levels of particulate matter can, for instance, indicate closeness of the device to a door or to a window. In this case, high levels of particulate matter would be due to polluted outdoor air.

The actuators 3a-3h, 4a-4e and the sensors 5a-5d have interfaces in order for them to communicate with one or more system controllers 6a, 6b. In some embodiments, any communication between the one or more system controllers 6a, 6b and the actuators 3a-3h, 4a-4e and/or sensors 5a-5d can be bidirectional or unidirectional. One the one hand, a bidirectional connection affords flexibility. On the other hand, unidirectional connection reduces complexity.

The one or more system controllers 6a, 6b may comprise one or more microcontrollers and/or one or more microprocessors. In some embodiments, the one or more system controllers 6a, 6b are one or more microcontrollers and/or one or more microprocessors. The one or more system controllers 6a, 6b may comprise one or more memories such as one or more non-volatile memories. That is, the one or more system controllers 6a, 6b can comprise one or more microcontrollers and one or more non-volatile memories. The one or more system controllers 6a, 6b can also comprise one or more microprocessors and one or more non-volatile memories. The one or more system controllers 6a, 6b can still be one or more microcontrollers having one or more non-volatile memories. The one or more system controllers 6a, 6b can also be one ore more microprocessors having one ore more non-volatile memories.

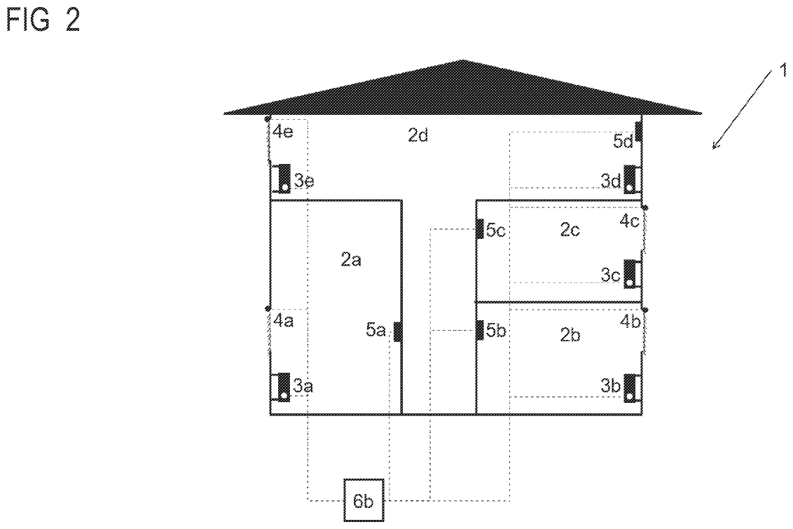

FIG. 1 and FIG. 2 show dashed lines to indicate communication links between the devices of an installation. In some embodiments, at least one of the links shown in FIG. 1 and in FIG. 2 employs encryption. In some embodiments, some of the actuators 3a-3h, 4a-4e and/or some of the sensors 5a-5d employ a Diffie-Hellman key exchange (or similar) to establish secure connections. In some embodiments, some of the actuators 3a-3h, 4a-4e and/or some of the sensors 5a-5d employ private and public keys of suitable length to establish secure connections.

The communication interface and/or the communication controller can, by way of example, rely on wireless solutions such as WLAN and/or KNX® RF, and/or Enocean®. Hard-wired solutions such as Ethernet® cables or KNX® cables are also considered. The choice of any wireless or hard-wired solution is typically influenced by bandwidth requirements. Sensors and/or actuators with video streaming functionality can, by way of example, require more bandwidth than other types of field devices.

In some embodiments, the actuators 3a-3h, 4a-4e and the sensors 5a-5d and the one or more system controllers 6a, 6b all use a common communication protocol. In some embodiments, the devices of an installation rely on a protocol such as KNX® or Modbus or LON, or BACnet®. The actuators 3a-3h, 4a-4e and the sensors 5a-5d and the one or more system controllers 6a, 6b can also rely on a proprietary protocol. The protocol may comprise a digital communication protocol.

The one or more system controllers 6a can be one or more devices inside the building 1 and/or inside the facility. In some embodiments, the one or more system controllers 6b are arranged outside the building 1 and/or outside the facility. The one or more system controllers 6b may, in particular, comprise a cloud computer. In some embodiments, an external system controller 6b may connect to the actuators 3a-3h, 4a-4e and to the sensors 5a-5d via the Internet.

The interface modules of the actuators 3a-3h, 4a-4e and of the sensors 5a-5d typically carry machine addresses. The machine addresses may be unique addresses. The one or more system controllers 6a, 6b upon discovery of actuators 3a-3h, 4a-4e or sensors 5a-5d assign a network address to each device 3a-3h, 4a-4e, 5a-5d. The network address is then used to send data packets from the one or more system controllers 6a, 6b to an actuator 3a-3h, 4a-4e or to a sensor 5a-5d or vice versa.

In some embodiments, the network is a TCP/IP based network. In this embodiment, the one or more system controllers 6a, 6b may assign network addresses in accordance with a direct host configuration protocol (DHCP). In some embodiments, the one or more system controllers 6a, 6b use a (static) lookup-up table to map machine addresses to network addresses.

Upon establishment of the network, the one or more system controllers 6a, 6b can poll (each of) the actuators 3a-3h, 4a-4e for its settings. The one or more system controllers 6a, 6b can, by way of example, regularly poll (each of) the actuators 3a-3h, 4a-4e for its settings. The one or more system controllers 6a, 6b can, by way of another example, iteratively poll (each of) the actuators 3a-3h, 4a-4e for its settings and/or for its operating modes and/or for its operating states. These settings and/or operating modes and/or operating states can, by way of example, indicate valve positions. They may as well indicate the positions of blinds or shutters.

The one or more system controllers 6a, 6b function to poll the sensors 5a-5d for their readings. The one or more system controllers 6a, 6b can, by way of example, regularly poll (each of) sensors 5a-5d. The one or more system controllers 6a, 6b can, by way of another example, iteratively poll (each of) the sensors 5a-5d.

The one or more system controllers 6a, 6b can use a suitable protocol such as a file transfer protocol or a hypertext transfer protocol to obtain readings from actuator devices 3a-3h, 4a-4e and/or from sensor devices 5a-5d. In some embodiments, the one or more system controllers 6a, 6b download readings from actuators 3a-3h, 4a-4e and/or from sensors 5a-5d via secure copy.

The one or more system controllers for assigning network addresses and for obtaining readings need not be the same. In some embodiments, at least one first system controller configures the network. At least one second system controller sees the network as configured by the first unit and gathers readings from actuators 3a-3h, 4a-4e and from sensors 5a-5d.

Once readings have been obtained from the actuators 3a-3h, 4a-4e and/or from the sensors 5a-5d, those readings can be normalised. The step of normalisation can be carried out for each actuator 3a-3h, 4a-4e and for each sensor 5a-5d. In some embodiments, the one or more system controllers 6a, 6b carry out the one or more normalisations.

In other words, a valve position of a thermal energy exchanger that can be employed in the building 1 varies continuously or in discrete steps between fully closed and fully open. In this case, the fully closed position is normalised to a value of 0 and the fully open is normalised to a value of 1. Any valve position in between fully closed and fully open is mapped to a value that corresponds to the actual degree of opening of the valve. The valve position can, by way of non-limiting example, comprise a valve stroke. In some embodiments, the valve position can be a valve stroke. Suppose a valve is 30% open. The corresponding normalised value then becomes 0.3. Settings of actuators 4a-4e for blinds are normalised in a similar or in the same fashion.

Likewise, readings from any temperature sensor such as sensor 5a can be normalised. In some embodiments, 18 degrees Celsius (291 Kelvin) may be the lowest acceptable indoor temperature for a residential building. Also, in this embodiment 28 degrees Celsius (301 Kelvin) can be the top end of the acceptable temperature range. An indoor temperature of 291 Kelvin is then mapped to a normalised value of 0. An indoor temperature of 301 Kelvin is mapped to a normalised value of 1. A temperature of 294 Kelvin is mapped to a value of 0.7. Readings from lighting sensors are normalised in a similar fashion or in the same fashion.

Presence detectors (or occupancy sensors) produce readings that differ from the readings of temperature sensors. While temperature sensors yield continuous readings, (infrared) presence detectors either detect or do not detect an individual. There are basically two indications from presence detectors and these are “detected an individual” or “detected no individual”. If no individual is detected, the reading from the presence detector will be normalised to 0. The reading obtained from the presence detector will in all other cases be normalised to 1.

The normalised signal from a presence detector can lie in between 0 and 1 due to uncertainty. That is, a normalised signal of 0.7 would indicate a 70% probability of someone being present in the vicinity of the presence detector. In some embodiments, values equal to or larger than 0.5 are rounded up. A normalised signal of 0.7 then becomes 1. Likewise, a normalised signal of 0.2 is rounded to 0.

The (normalised) signal can comprise a series of values. Suppose temperatures are measured at 6 a.m. in the morning, then at 7 a.m., at 8 a.m., and so forth. In one illustrative example, the temperature measurement may be 18 degrees Celsius (291 Kelvin) at 6 a.m., 19 degrees Celsius (292 Kelvin) at 7 a.m., and 20 degrees (293 Kelvin) at 8 a.m. In this embodiment, the one or more system controllers 6a, 6b obtain readings every hour. At 8 a.m. the series of normalised values is 0, 0.1, 0.2. The one or more system controllers 6a, 6b preferably form time series of (temperature) measurements with one, two, three, four, eight, sixteen, thirty-two, sixty-four etc. values. The one or more system controllers 6a, 6b advantageously obtain readings every minute, every fifteen minutes, twice per hour, once per hour, every two hours, every four hours, every eight hours, once per day etc. The one or more system controllers 6a, 6b obtain settings and/or operating modes and/or operating states from the actuators 3a-3h, 4a-4e in a similar or in the same fashion.

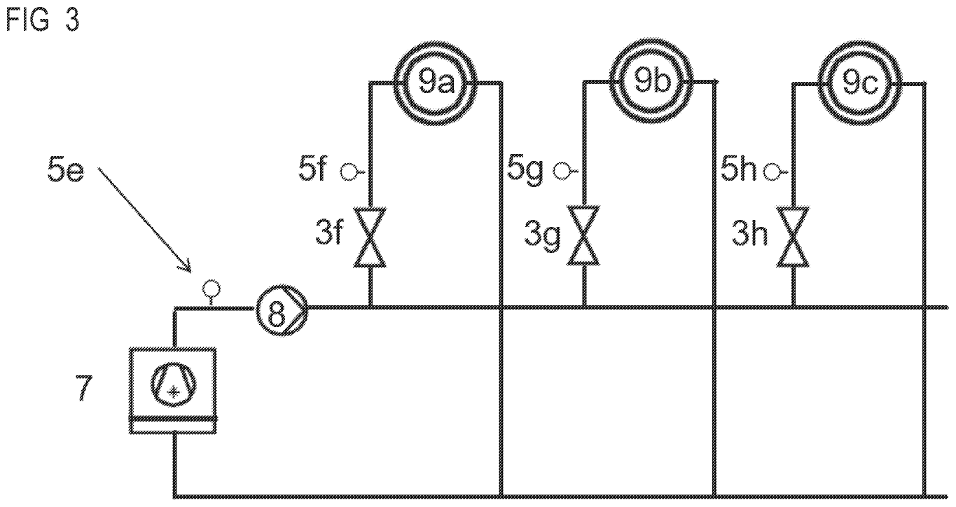

Now referring to FIG. 3, system for heating and/or ventilation and/or air-conditioning is schematically shown. The system comprises a heat pump 7, a pump 8 and several temperature sensors 5e-5h. A plurality of valves having valve actuators 3f-3h each connects to a thermal energy exchanger 9a-9c.

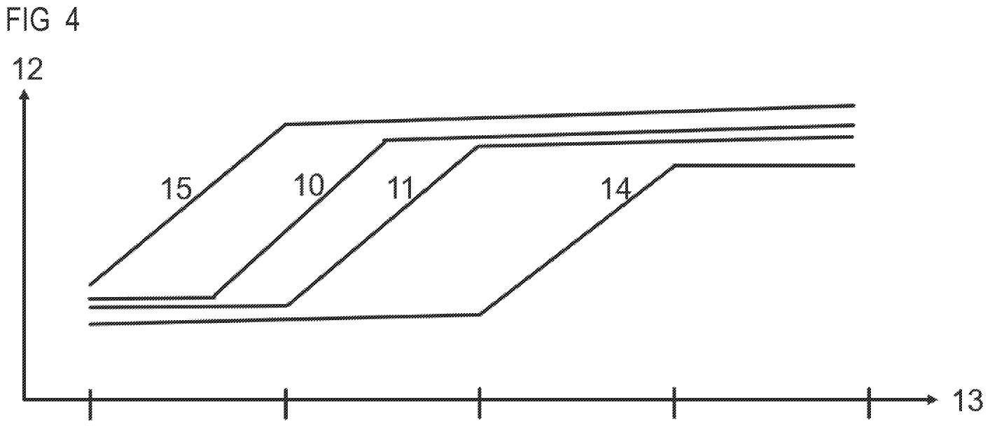

Now turning to FIG. 4, a first time series of signals is read from a first sensor such as a first temperature sensor. A second time series 11 of signals is read from a second sensor such as a second temperature sensor. A first time series 10 of measured values is produced from the first time series of signals. A second time series 11 of measured values is produced from the second time series of signals.

In some embodiments, an analog-to-digital converter provides conversion of analog signals from the components sensors into (digital) measures. The analog-to-digital converter can be an integral part of the one or more system controllers 6a, 6b. That is, the analog-to-digital converter and the one or more system controllers 6a, 6b are arranged on the same system-on-a-chip.

In some embodiments, the one or more system controllers 6a, 6b comprise a sigma-delta converter. The sigma-delta converter provides conversion of analog signals from the sensors into (digital) measures. The sigma-delta converter can be an integral part of the one or more system controllers 6a, 6b. That is, the sigma-delta converter and the one or more system controllers 6a, 6b are arranged on the same system-on-a-chip.

FIG. 4 shows a plot of the averaged values of the first time series 10 and the average values of the second time series 11. The measured and averaged values 12 are plotted versus time 13. In addition to the measured and averaged values, FIG. 4 shows a lower-bound series 14 for the second time series 11 and an upper-bound series 15 for the second time series 11.

The lower-bound series 14 can be a lower envelope of the second time series 11. That is, the averaged values 11 of the second time series exhibit scatter. Also, the readings are not always synchronously obtained from the actuators 3a-3h, 4a-4e and from the sensors 5a-5h. What's more, the resolution of the actuators (3a-3h, 4a-4e) and of the sensors 5a-5h may be non-uniform and coarse. The actuators 3a-3h, 4a-4e and/or the sensors 5a-5h can also be calibrated differently.

Minimum values of the second time series are iteratively determined for equidistant intervals of time. The lower envelope then comprises these minimum values of the second time series. Ideally, the lower envelope consists of these minimum values of the second time series 11.

The upper-bound series 15 can be an upper envelope of the second time series 11. That is, the averaged values 11 of the second time series exhibit scatter. Minimum values of the second time series are iteratively determined using equidistant intervals of time. The upper envelope then comprises these minimum values of the second time series. In some embodiments, the upper envelope consists of these minimum values of the second time series 11.

In some embodiments, the lower-bound series 14 represents quantile values of the second time series 11. That is, the measured values 11 of the second time series 11 exhibit scatter. Quantile values of the second time series 11 are iteratively determined using equidistant intervals of time. For example, those quantiles can be 90% quantiles. That is, 90% of all measured values of the second time series 11 exceed the 90% quantile. The quantiles can, by way of another non-limiting example, be 95% quantiles. That is, 95% of all measured values of the second time series 11 exceed the 95% quantile. The quantiles can, by way of yet another non-limiting example, be 99% quantiles. That is, 99% of all measured values of the second time series 11 exceed the 99% quantile. The lower-bound series 14 then comprises such quantile values of the second time series 11. In some embodiments, lower-bound series 14 consists of such quantile values of the second time series 11.

In some embodiments, the upper-bound series 15 represents quantile values of the second time series 11. That is, the measured values of the second time series 11 exhibit scatter. Quantile values of the second time series 11 are iteratively determined using equidistant intervals of time. For example, those quantiles can be 90% quantiles. That is, 90% of all measured values of the second time series 11 are less than the 90% quantile. The quantiles can, by way of another non-limiting example, be 95% quantiles. That is, 95% of all measured values of the second time series 11 are less than the 95% quantile. The quantiles can, by way of yet another non-limiting example, be 99% quantiles. That is, 99% of all measured values of the second time series 11 are less than the 99% quantile. The upper-bound series 15 then comprises such quantile values of the second time series 11. Ideally, upper-bound series 15 consists of such quantile values of the second time series 11.

The first time series 10 can be found to be within the lower and upper bounds of the second time series 11. In simple terms, the first and the second time series 10, 11 are then similar.

It can be necessary to compute a quantitative measure of similarity. The quantitative measure of similarity affords comparisons between triplets. The quantitative measure of similarity s between the first time series 10 and the second time series 11 is determined using a moving window. That is, a distance d between the first time series 10 and the second time series 11 is iteratively determined using equidistant intervals of time. The distance d is rescaled using a first multiplicative factor c₁. Where the distance d exceeds 1/c₁, a second multiplicative factor c₂ is applied:

$$s = \{ \begin{matrix}1 - d \cdot {c}_{1} & where d \leq d 1 / {c}_{1} \\ ( 1 - d \cdot {c}_{1} ) \cdot {c}_{2} & where d > 1 / {c}_{1}\end{matrix}$$

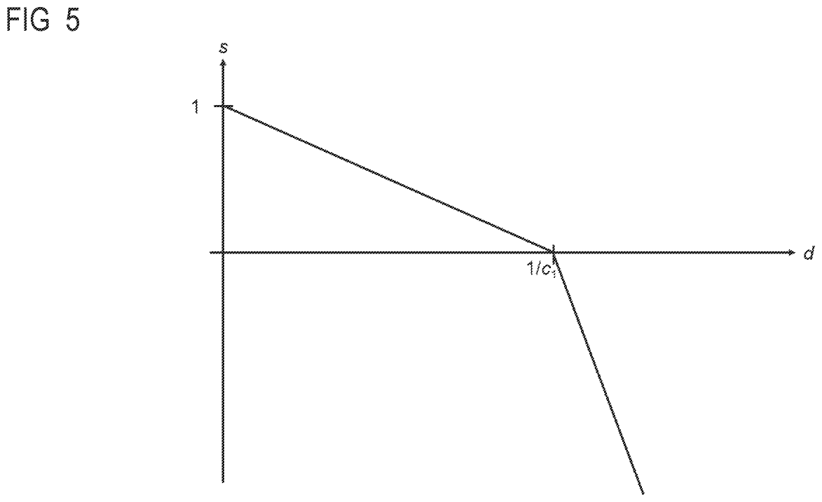

The measure of similarity s will equal 1 if the first time series 10 matches the second time series 11. The similarity score s can become negative as illustrated in FIG. 5. That is, the measure of similarity s is positive so long as the distance measure d is less than or equal to 1/c₁. The similarity score s otherwise is negative. Where the measure of similarity s is negative, the slope of the curve of s versus d will be −c₁·c₂.

The use of two multiplicative factors c₁ and c₂ and of negative similarities s is justified because similarities of time series are often coincidental. While similarities can be coincidental, any lack of such similarities usually is a strong indicator of dissimilar time series.

Signals indicative of flow can be exploited to distinguish between similar and dissimilar time series. A plethora of valves is found on the market where such valves provide flow measurements. For example, the patent application US2022/019249A1 discloses a valve having a flow sensor. Another flow sensor situated in a fluid path is disclosed in the patent CN109240080B.

Accordingly, a signal indicative of flow is obtained from a valve or from a dedicated flow sensor. If there is no flow, time series obtained from sensors associated with the valve or with the flow sensor will be treated as dissimilar. More specifically, time series obtained from temperature sensors associated with the valve or with the flow sensor will be disregarded.

Signals from flow sensors are not always available. Where there are no signals from flow sensors, other signals can indicate no flow. For example, the signal of a sensor installed at a thermal energy exchanger may substantially not change over time. Since the signal from that sensor does not change, there is likely no flow in through the thermal energy exchanger. More specifically, a moving average of a temperature signal from such a sensor may change by less than 0.2 Kelvin over ten minutes. The moving average may even change by less than 0.5 Kelvin over ten minutes. The window size for calculating the moving average can, by way of non-limiting examples, the thirty seconds or one minute. Any time series obtained from that sensor installed at the thermal energy exchanger will then be disregarded.

A no flow condition can also be determined where a time series originating from a temperature sensor closely fluctuates around room temperature. A no flow condition can still be determined where a time series originating from a temperature sensor closely fluctuates around a reference temperature. For example, a first sensor installed at or near a thermal energy exchanger indicates temperatures fluctuating between 294.3 Kelvin and 295.2 Kelvin over ten minutes. A second sensor installed elsewhere and recording room temperature indicates a room temperature of 294.5 Kelvin. Since the time series originating from the first sensor closely fluctuates around room temperature, there is likely no flow through the thermal energy exchanger. Any time series originating from that sensor installed at or near the thermal energy exchanger will be disregarded.

There may be a determination of zero flow through a thermal energy exchanger if a time series fluctuates by less than 0.8 Kelvin around room temperature. There may also be a determination of zero flow through a thermal energy exchanger if a time series fluctuates by less than 0.8 Kelvin around a reference temperature. In a similar embodiment, the determination of zero flow is made where fluctuations are below 0.5 Kelvin or below 0.3 Kelvin. The determination may be made by the one or more system controllers 6a, 6b.

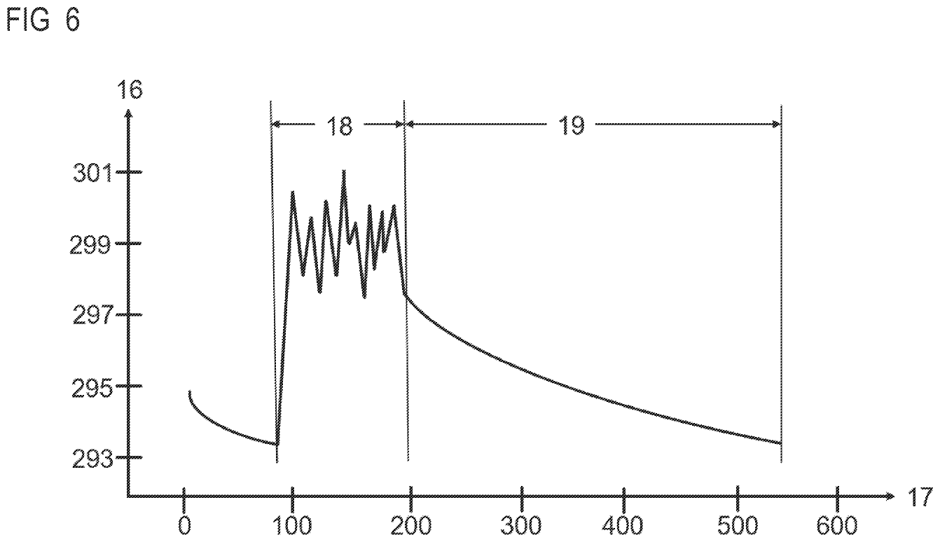

Time series can exhibit an exponential increase or an exponential decay. To that end, FIG. 6 shows a plot of temperature 16 in Kelvin versus time 17 in seconds. In a first domain 18, a time series obtained from a temperature sensor fluctuates. A second domain 19 follows the first domain 18. The second domain 19 exhibits an exponential decay.

Time series exhibiting an exponential decay will be tagged. In some embodiments, the one or more system controllers 6a, 6b will tag time series exhibiting the exponential decay. After the tagging, those tagged time series are dealt with in the same or in a similar way as time series associated with flow measurements. Those time series are considered dissimilar. In some embodiments, the one or more system controllers 6a, 6b classifies those time series as dissimilar.

In some embodiments, time series exhibiting an exponential decay are considered as indicative of zero flow. Those time series my be disregarded. In some embodiments, triplets comprising such time series are tagged as dissimilar.

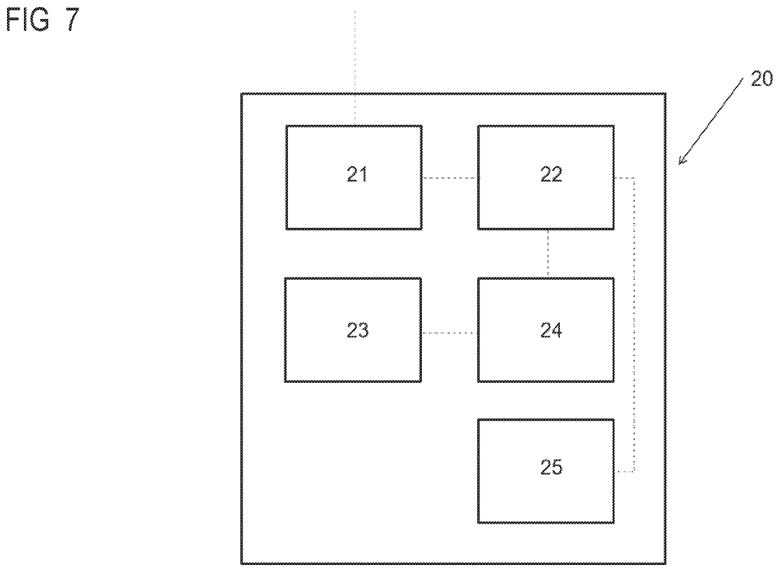

Eventually, triplets comprising two time series and an operating mode and/or an operating state become available. In some embodiments, these triplets become available at the one or more system controllers 6a, 6b. A user and/or an operator can then interact with the one or more system controllers 6a, 6b and select triplets of interest. To that end, the user and/or the operator can harness the device 20 shown in FIG. 7. In an embodiment, the device 20 shown in FIG. 7 comprises a mobile handheld device. In a special embodiment, the device 20 shown in FIG. 7 is a mobile handheld device.

The device 20 may be in communicative connection with the one or more system controllers 6a, 6b. To that end, the device 20 comprises a network adapter 21 such as a wireless network adapter. The device 20 receives signals indicative of the triplets via the network adapter 21 and forwards the signals to the processor 22. The processor 22 produces triplets from the signals received by the network adapter 21. The processor 22 produces presentation signals from the triplets. The presentation signals may be associated with a graphical user interface. The processor 22 forwards the presentation signals to a human-machine interface 23, 24.

A human-machine interface 23, 24 according to this disclosure preferably comprises a display 23 with a suitable resolution. Suitable resolutions include, but are not limited to 426×320 pixels, 470×320 pixels, 640×480 pixels, 960×720 pixels. In a preferred embodiment, the human-machine interface 23, 24 of this disclosure comprises a monochrome or a colour display 23. The display 23 may be a liquid-crystal display. The display 23 may also comprise organic light-emitting diodes. The human-machine interface 23, 24 preferably also provides input devices 24 such as, by way of non-limiting examples, keyboards, buttons, touch screens, capacitive touch screens, voice recognition, track points etc. The device 20 further provides a memory 25 in communicative connection with the processor 22.

When the user and/or the operator has selected certain triplets, the device 20 returns the selected triplets to the one or more system controllers 6a, 6b. The selected triplets are preferably returned via the network adapter 21.

The one or more system controllers 6a, 6b receive signals indicative of the selected triplets. One or more processors of the one or more system controllers 6a, 6b then produce selected triplets from the received signals indicative of selected triplets. The one or more system controllers 6a, 6b use the selected triplets to perform tests of the building 1 and/or of the facility.

Where a test reveals that time series that should be similar are not similar, an alert is produced. The alert can, by way of another non-limiting example, be indicative of a faulted pump 8 of the system for heating and/or ventilation and/or air-conditioning shown in FIG. 3.

The alert can, by way of another non-limiting example, be indicative of a window left open. The one or more system controllers 6a, 6b can comprise one or more human-machine interfaces to communicate those alerts to a user and/or to an operator. The one or more system controllers 6a, 6b can also forward alerts to the device 20 shown in FIG. 7. More specifically, the one or more system controllers 6a, 6b can forward alerts to one or more mobile handheld devices 20.

The network adapter 21 of the device 20 thus receives signals indicative of the alerts. The processor 22 produces alert data from the signals indicative of the alerts. More specifically, the processor 22 can produce alert data to be presented to the user and/or to the operator via a graphical user interface. The human-machine interface 23, 24 of the device 20 preferably functions to present alerts to a user and/or to an operator via the graphical user interface.

As described in detail herein, some embodiments of the teachings herein include a method of detecting faults in a structure (1) having a data network and at least one first actuator (3a-3h, 4a-4e) connecting to the data network, and having first and second sensors (5a-5h), each sensor (5a-5h) connecting to the data network, the method comprising:
obtaining via the data network from the at least one first actuator (3a-3h, 4a-4e) one or more signals indicative of a test operating mode and/or of a test operating state and from each of the first and second sensors (5a-5h) one or more signals indicative of a time series of test readings;
producing a test operating mode and/or a test operating state from the one or more signals indicative of a test operating mode and/or of a test operating state and a first time series of test values from the one or more signals obtained from the first sensor (5a-5h) and a second time series of test values from the one or more signals obtained from the second sensor (5a-5h);
searching for the test operating mode and/or for the test operating state in a first list, and searching for the first and second sensors (5a-5h) in a second list;
if the test operation mode is found in the first list and the first and second sensors (5a-5h) are found in the second list:
determining a test numerical measure s between the first time series of test values and the second time series of test values, the test numerical measure s being a predefined constant when the first time series of test values matches the second time series of test values and otherwise deviating from the predefined constant;
determining a test deviation of the test numerical measure s from the predefined constant and comparing the test deviation to a test threshold value;
if the test deviation exceeds the test threshold value:
producing fault data based on the test deviation; and
using the fault data to alert a user and/or an operator.

In some embodiments, the structure comprises a building. In some embodiments, the first sensor (5a-5h) is different from the second sensor (5a-5h). The first sensor (5a-5h) may be different from the at least one first actuator (3a-3h, 4a-4e). The second sensor (5a-5h) may be different from the at least one first actuator (3a-3h, 4a-4e).

In some embodiments, the numerical measure s comprises a measure of similarity s. In some embodiments, the numerical measures s comprises a numerical value s.

The test numerical measure may be determined if the test operation mode is found in the first list and the first and second sensors (5a-5h) are each found in the second list.

In some embodiments, the method comprises comparing the test deviation to a test threshold value or to the test threshold value.

The instant disclosure also deals with any of the aforementioned methods, the method comprises producing a test operating mode and/or a test operating state from the one or more signals indicative of a test operating mode and/or of a test operating state and a first time series of test values from the one or more signals indicative of a time series of test readings obtained from the first sensor (5a-5h) and a second time series of test values from the one or more signals indicative of a time series of test readings obtained from the second sensor (5a-5h).

In some embodiments, the method comprises determining a test numerical measure s between the first time series of test values and the second time series of test values, the test numerical measure s being a predefined constant when the first time series of test values matches the second time series of test values and deviating from the predefined constant when the first time series of test values is different from the second time series of test values.

In some embodiments, the first list and the second list form a single list. That is, the test operating modes and/or the test operating states and the sensors (5a-5h) are searched for in the same list. A single list reduces the complexity of the solution.

In some embodiments, the first list comprises a lookup table of operating modes and/or of operating states. In some embodiments, the second list comprises a lookup table of sensors.

In some embodiments, the predefined constant is one. In some embodiments, the predefined constant is zero.

In some embodiments, the method comprises one or more iterations of: determining a distance d between the first time series of test values and the second time series of test values; rescaling the determined distance d between the first time series of test values and the second time series of test values; and adding the rescaled distance between the first time series of test values and the second time series of test values to or subtracting the rescaled distance between the first time series of test values and the second time series of test values from the test numerical measure s.

In some embodiments, the method comprises one or more iterations of: applying a moving window filter to the first time series of test values to obtain a first filtered test value; applying the moving window filter to the second time series of test values to obtain a second filtered test value; determining a distance d between the first filtered test value and the second filtered test value; rescaling the determined distance d between the first filtered test value and the second filtered test value; and adding the rescaled distance to or subtracting the rescaled distance from the test numerical measure s.

In some embodiments, the moving window filter has a window size of sixty seconds or less. In some embodiments, the moving window filter has a window size of twelve seconds or less. In some embodiments, the moving window filter has a window size of six seconds or less. Small window sizes may improve on granularity.

In some embodiments, each iteration comprises: comparing the determined distance d to a distance threshold value; and if the determined distance d exceeds the distance threshold value: using a first multiplicative factor c₁ to rescale distance d; otherwise: using a second multiplicative factor c₂ to rescale the determined distance d; wherein the first multiplicative factor c₁ is different from the second multiplicative factor c₂.

In some embodiments, the first multiplicative factor c₁ exceeds the second multiplicative factor c₂, c₁>c₂. In some embodiments, the second multiplicative factor c₂ exceeds the first multiplicative factor c₁, c₁<c₂.

In some embodiments, the aforementioned iterative methods comprise more than two, more than five, or even more than ten iterations. Many iterations may improve on granularity.

In some embodiments, the method comprises: if the test deviation exceeds the test threshold value: producing the fault data based on the test deviation and based on at least one of: the at least one first actuator (3a-3h, 4a-4e), the first sensor (5a-5h), the second sensor (5a-5h), and the test numerical measure s.

In some embodiments, the method comprises if the test deviation exceeds the test threshold value: producing the fault data based on the test deviation and based on at least two of: the at least one first actuator (3a-3h, 4a-4e), the first sensor (5a-5h), the second sensor (5a-5h), and the test numerical measure s.

In some embodiments, the method comprises, if the test deviation exceeds the test threshold value: producing the fault data based on the test deviation and based on at least three of: the at least one first actuator (3a-3h, 4a-4e), the first sensor (5a-5h), the second sensor (5a-5h), and the test numerical measure s. The more data are added to the fault data, the better the user and/or the operator will be informed.

In some embodiments, the first sensor (5a-5h) is associated with a thermal energy exchanger, the thermal energy exchanger being installed at or near a window, and the second sensor is or comprises a room temperature sensor (5a-5h), the method comprising: if the test deviation exceeds the test threshold value: producing fault data indicative of the window left open based on the test deviation; and using the fault data indicative of the window left open to alert the user and/or the operator.

In some embodiments, a valve (3a-3d) of a thermal energy exchanger comprises the first temperature sensor (5a-5h). Windows that are left open are a major cause of wasted power.

The thermal energy exchanger may be installed less than five meters from the window, less than two meters from the window, or even less than one meter from the window. These distances refer to the closest distance between the window and the thermal energy exchanger.

In some embodiments, the method comprises: obtaining via the data network from the at least one first actuator (3a-3h, 4a-4e) one or more signals indicative of an initial operating mode and/or of an initial operating state and from each of the first and second sensors (5a-5h) one or more signals indicative of a time series of initiation readings; producing an initial operating mode and/or an initial operating state from the one or more signals indicative of an initial operating mode and/or of an initial operating state and a first time series of initiation values from the one or more signals indicative of a time series of initiation readings obtained from the first sensor (5a-5h) and a second time series of initiation values from the one or more signals indicative of a time series of initiation readings obtained from the second sensor (5a-5h); and determining an initial numerical measure s between the first time series of initiation values and the second time series of initiation values, the initial numerical measure s being the predefined constant when the first time series of initiation values matches the second time series of initiation values and otherwise deviating from the predefined constant.

In some embodiments, the first time series of initiation values comprises a first time series of initial values. More specifically, the first time series of initiation values can be a first time series of initial values. In some embodiments, the second time series of initiation values comprises a second time series of initial values. In some embodiments, the second time series of initiation values can be a second time series of initial values.

In some embodiments, the method comprises: producing an initial operating mode and/or an initial operating state from the one or more signals indicative of an initial operating mode and/or of an initial operating state and a first time series of initiation values from the one or more signals indicative of a time series of initiation readings obtained from the first sensor (5a-5h) and a second time series of initiation values from the one or more signals indicative of a time series of initiation readings obtained from the second sensor (5a-5h).

In some embodiments, the method comprises determining an initial numerical measure s between the first time series of initiation values and the second time series of initiation values, the initial numerical measure s being the predefined constant when the first time series of initiation values matches the second time series of initiation values and deviating from the predefined constant when the first time series of initiation values is different from the second time series of initiation values.

In some embodiments, the method comprises one or more iterations of: determining a distance d between the first time series of initiation values and the second time series of initiation values; rescaling the determined distance d between the first time series of initiation values and the second time series of initiation values; and adding the rescaled distance between the first time series of initiation values and the second time series of initiation values to or subtracting the rescaled distance between the first time series of initiation values and the second time series of initiation values from the initial numerical measure s.

In some embodiments, the method comprises: applying the moving window filter to the first time series of initiation values to obtain a first filtered initiation value; applying the moving window filter to the second time series of initiation values to obtain a second filtered initiation value; determining a distance d between the first filtered initiation value and the second filtered initiation value; rescaling the determined distance d between the first filtered initiation value and the second filtered initiation value; and adding the rescaled distance between the first filtered initiation value and the second filtered initiation value to or subtracting the rescaled distance between the first filtered initiation value and the second filtered initiation value from the initial numerical measure s.

In some embodiments, the moving window filter has a window size of sixty seconds or less. In some embodiments, the moving window filter has a window size of twelve seconds or less. In some embodiments, the moving window filter has a window size of six seconds or less. Small window sizes may improve on granularity.

In some embodiments, each iteration comprises: comparing the determined distance d to the distance threshold value; and if the determined distance d exceeds the distance threshold value: using the first multiplicative factor c₁ to rescale the determined distance d; otherwise: using the second multiplicative factor c₂ to rescale the determined distance d.

In some embodiments, the method comprises: producing the initiation data based on the initial numerical measure s and based on at least one of: the at least one first actuator (3a-3h, 4a-4e), the first sensor (5a-5h), the second sensor (5a-5h), an initial deviation of the initial numerical measure s from the predefined constant; forwarding the initiation data to the user and/or to the operator; after forwarding the initiation data, receiving from the user and/or from the operator a choice signal indicative of an affirmative or a negative choice made by the user and/or by the operator; producing a binary choice value indicative of the affirmative choice or of the negative choice from the choice signal; and if the binary choice value is affirmative: adding the initial operating mode and/or the initial operating state to the first list.

In some embodiments, the method comprises determining the test threshold value as a function of the initiation data.

In some embodiments, the method comprises calculating the test threshold value as a function of the initiation data.

In some embodiments, the method comprises if the binary choice value is affirmative, adding the initial operating mode and/or the initial operating state as an operating mode and/or as an operating state to the first list.

In some embodiments, the method comprises, if the binary choice value is affirmative, adding the first and second sensors (5a-5h) to the second list.

In some embodiments, the method comprises: determining a measure of change of the first time series of initiation values; and if the measure of change exceeds a change threshold value: forwarding the initiation data to the user and/or to the operator.

In some embodiments, the measure of change is determined by applying a regression analysis to the first time series of initiation values, the regression analysis yielding a slope and the slope becoming the measure of change. In some embodiments, the measure of change is determined by determining a variance of the first time series of initiation values, the variance becoming the measure of change. The change threshold value may be a predetermined change threshold value. A predetermined change threshold value rather than a variable change threshold value affords a solution that is less prone to misconfiguration.

In some embodiments, the method comprises: determining an or the initial deviation of the initial numerical measure s from the predefined constant and comparing the initial deviation to an initial threshold value; and if the initial deviation is less than the initial threshold value, adding the initial operating mode and/or the initial operating state to the first list.

In some embodiments, the initial threshold value is the same as the test threshold value. Same or similar threshold values reduce the complexity of the solution and reduce the amount of memory required for storing such values. Same or similar threshold values also lower the odds of misconfigurations. In some embodiments, the initial threshold value is different from the test threshold value. Different threshold values afford greater flexibility. More specifically, users can configure different thresholds for test setup and test execution.

In some embodiments, the method comprises, if the initial deviation is less than the initial threshold value, adding the initial operating mode and/or the initial operating state as an operating mode and/or as an operating state to the first list.

In some embodiments, the method comprises, if the initial deviation is less than the initial threshold value, adding the first and second sensors (5a-5h) to the second list.

Some embodiments include a computer program comprising instructions system controllers (6a, 6b) in communicative connection with a data network to execute one or more of the methods described herein. Some embodiments include a computer-readable medium storing the aforementioned computer program. Some embodiments include a computer-readable medium comprising instructions which, when executed by one or more system controllers (6a, 6b) in communicative connection with the data network, cause the one or more system controllers (6a, 6b) to carry out one or more of the methods of the present disclosure.

Any steps of a procedure described in the present disclosure can be embodied in hardware and/or in a software module executed by a processor. Any steps of such a procedure can also be embodied in a software module executed by a processor inside a container using operating system level virtualisation. Any steps of such a procedure can still be embodied in a cloud computing arrangement. In some embodiments, any steps of a procedure described in the present disclosure may be implemented in a combination of the above embodiments. The software may include a firmware and/or a hardware driver run by the operating system and/or an application program. Thus, the disclosure also relates to a computer program product for performing the operations presented herein. If implemented in software, the functions described may be stored as one or more instructions on a computer-readable medium. Storage media that can be used include, by way of non-limiting examples, random access memory (RAM) and/or read only memory (ROM) and/or flash memory. Storage media can, by way of non-limiting examples, also include EPROM memory and/or EEPROM memory and/or registers and/or a hard disk and/or a removable disk. Further storage media can, by way of non-limiting examples, include other optical disks and/or any available media that can be accessed by a computer. Storage media can still, by way of non-limiting example, include any other IT equipment and appliance.

It should be understood that the foregoing relates only to certain embodiments of the teachings of the present disclosure. Numerous changes can be made therein without departing from the scope of the disclosure as defined by the following claims. It should also be understood that the disclosure is not restricted to the illustrated embodiments. Various modifications can be made within the scope of the following claims.

### REFERENCE NUMERALS

1 building
2a-2d rooms
3a-3h valve actuators (of thermal energy exchangers)
4a-4e actuators for windows, window blinds and lights (switches, dimmers)
5a-5h sensors
6a system controller inside the building
6b system controller outside the building
7 heat pump
8 pump
9a-9c thermal energy exchanger
10 time series
11 time series
12 ordinate axis indicative of a received signal
13 abscissa axis indicative of time
14 lower-bound series, lower envelope
15 upper-bound series, upper envelope
16 ordinate axis indicative of temperature
17 abscissa axis indicative of time
18 domain
19 domain
20 device
21 network adapter
22 processor, especially a microcontroller and/or a microprocessor
23 display
24 one or more input devices
25 memory

1. A method of detecting faults in a structure having a data network connecting a first actuator, a first sensor, and a second sensor, the method comprising:
obtaining via the data network from the first actuator a first signal indicative of a test operating mode and from the first sensor and the second sensor respective signals indicative of a time series of test readings;
producing a test operating mode in response;
searching for the test operating mode in a first list, and searching for the first sensor and the second sensor in a second list;
if the test operation mode is found in the first list and the first sensor and the second sensor are found in the second list, determining a test numerical measure between the first time series of test values and the second time series of test values, the test numerical measure including a predefined constant when the first time series of test values matches the second time series of test values and otherwise deviating from the predefined constant; and
determining a test of the test numerical deviation measure from the predefined constant, and if the test deviation exceeds a test threshold value: producing fault data based on the test deviation and using the fault data to alert a user.

2. The method according to claim 1, the method comprising one or more iterations of:
determining a distance between the first time series of test values and the second time series of test values;
rescaling the determined distance between the first time series of test values and the second time series of test values; and
adding the rescaled distance between the first time series of test values and the second time series of test values to or subtracting the rescaled distance between the first time series of test values and the second time series of test values from the test numerical measure.

3. The method according to claim 1, the method comprising one or more iterations of:
applying a moving window filter to the first time series of test values to obtain a first filtered test value;
applying the moving window filter to the second time series of test values to obtain a second filtered test value;
determining a distance between the first filtered test value and the second filtered test value;
rescaling the determined distance between the first filtered test value and the second filtered test value; and
adding the rescaled distance to or subtracting the rescaled distance from the test numerical measure.

4. The method according to claim 2, wherein each iteration comprises:
comparing the determined distance to a distance threshold value; and
if the determined distance exceeds the distance threshold value, using a first multiplicative factor to rescale the determined distance;
otherwise, using a second multiplicative factor to rescale the determined distance;
wherein the first multiplicative factor is different from the second multiplicative factor.

5. The method according to claim 1, the method comprising, if the test deviation exceeds the test threshold value:
producing the fault data based on the test deviation and based on at least one of: the at least one first actuator, the first sensor, the second sensor, and the test numerical measure.

6. The method according to claim 1, the method comprising:
obtaining via the data network from the first actuator one or more signals indicative of an initial operating mode and from each of the first sensor and the second sensor signals indicative of a time series of initiation readings;
producing an initial operating mode from the signals indicative of an initial operating mode and/or of an initial operating state and a first time series of initiation values in response; and
determining an initial numerical measure between the first time series of initiation values and the second time series of initiation values, the initial numerical measure including the predefined constant when the first time series of initiation values matches the second time series of initiation values and otherwise deviating from the predefined constant.

7. The method according to claim 6, the method comprising one or more iterations of:
determining a distance between the first time series of initiation values and the second time series of initiation values;
rescaling the determined distance between the first time series of initiation values and the second time series of initiation values; and
adding the rescaled distance between the first time series of initiation values and the second time series of initiation values to or subtracting the rescaled distance between the first time series of initiation values and the second time series of initiation values from the initial numerical measure.

8. The method according to claim 7, the method comprising one or more iterations of:
applying the moving window filter to the first time series of initiation values to obtain a first filtered initiation value;
applying the moving window filter to the second time series of initiation values to obtain a second filtered initiation value;
determining a distance between the first filtered initiation value and the second filtered initiation value;
rescaling the determined distance between the first filtered initiation value and the second filtered initiation value; and
adding the rescaled distance between the first filtered initiation value and the second filtered initiation value to or subtracting the rescaled distance between the first filtered initiation value and the second filtered initiation value from the initial numerical measure.

9. The method according to claim 7, each: iteration comprising:
comparing the determined distance to the distance threshold value; and
if the determined distance exceeds the distance threshold value, using the first multiplicative factor c₁ to rescale the determined distance;
otherwise using the second multiplicative factor c₂ to rescale the determined distance.

10. The method according to claim 6, the method comprising:
producing the initiation data based on the initial numerical measure and based on at least one of: the at least one first actuator, the first sensor, the second sensor, an initial deviation of the initial numerical measure s from the predefined constant;
forwarding the initiation data to the user;
after forwarding the initiation data, receiving from the user a choice signal indicative of an affirmative or a negative choice made by the user;
producing a binary choice value indicative of the affirmative choice or of the negative choice from the choice signal; and
if the binary choice value is affirmative, adding the initial operating mode and/or the initial operating state to the first list.

11. The method according to claim 10, the method comprising determining the test threshold value as a function of the initiation data.

12. The method according to claim 6, the method comprising:
determining a measure of change of the first time series of initiation values; and
if the measure of change exceeds a change threshold value, forwarding the initiation data to the user and/or to the operator.

13. The method according to claim 6, the method comprising:
determining an or the initial deviation of the initial numerical measure from the predefined constant and comparing the initial deviation to an initial threshold value; and
if the initial deviation is less than the initial threshold value, adding the initial operating mode and/or the initial operating state to the first list.
